(19) United States
(12) Patent Application Publication
(10) Pub. No.: US 2008/0158900 A1
(43) Pub. Date: Jul. 3, 2008

(54) OVERHEAD CONSOLE PROJECTOR LAMP OPTICS

(75) Inventors: John Lee Showalter, Rochestser Hills, MI (US); Rodney James Tindall, Zeeland, MI (US); Mark Kadzban, Grandville, MI (US); Robert Hamelink, Hamilton, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/963,108

(22) Filed: Dec. 21, 2007

Related U.S. Application Data
(60) Provisional application No. 60/876,514, filed on Dec. 22, 2006.

(51) Int. Cl. B60Q 3/02

(52) U.S. Cl. 362/490

(57) ABSTRACT

The invention relates to overhead console projector lamp optics, and more particularly, optics for an overhead console projector lamp for the interior of a vehicle. An overhead console projector lamp for the interior of a vehicle can include at least one projector lamp set, a light source, and a reflector. The projector lamp set includes at least one projector lamp that includes a converging lens. The overhead console projector lamp can be configured to produce a narrow beam of light that can be focused on an object in the interior of the vehicle.

### CROSS REFERENCE TO RELATED APPLICATIONS

This application claims priority to U.S. Provisional Application No. 60/876,514, filed Dec. 22, 2006, the disclosure of which is incorporated by reference herein in its entirety.

### TECHNICAL FIELD

The invention relates to overhead console projector lamp optics, and more particularly, optics for an overhead console projector lamp for the interior of a vehicle.

### BACKGROUND

The following background is provided simply as an aid in understanding the disclosed device and is not admitted to describe or constitute prior art.

The present device is generally related to lighting technology. Specifically, the device described below is directed to an interior light for a vehicle.

Generally, vehicle lighting for the interior of a vehicle, such as a courtesy or dome lamp, is a simple system, similar to those used for home lighting applications. For example, the purpose of a conventional light mounted on the ceiling of the vehicle interior is to illuminate the entire passenger compartment. Accordingly, conventional courtesy and dome lighting systems are designed to provide light in a diffuse or unfocused manner. Generally, little if any consideration is given to whether any stray light is produced. Conventional lighting systems, such as courtesy and dome lamps, lack the ability to concentrate or focus the emitted light on certain points or objects in the passenger compartment (e.g., a map being held by the driver, the dashboard, etc.). Conventional map or task lamps can provide focused light but have particular aesthetic appearances. Accordingly, there is a need for an interior light with a different aesthetic appearance that can illuminate a vehicle interior with defined light patterns.

### SUMMARY

According to an embodiment, an overhead console projector lamp for the interior of a vehicle includes at least one projector lamp set comprising a light source, a reflector, and at least one projector lamp that includes a converging lens, wherein the reflector is configured to include a first focal point and a second focal point, wherein the light source is arranged at the first focal point of the reflector, wherein the second focal point is located between the reflector and the converging lens.

According to an embodiment, a projector lamp set for the interior of a vehicle, includes a light source, a reflector, and at least one projector lamp that includes a converging lens, wherein the reflector is configured to include a first focal point and a second focal point, wherein the light source is arranged within the reflector at the first focal point, wherein the second focal point is located between the reflector and the converging lens.

### BRIEF DESCRIPTION OF THE DRAWINGS

It is to be understood that both the foregoing general description and the following detailed description are exemplary and explanatory only. These and other features, aspects and advantages will become apparent from the following description and the accompanying exemplary embodiments shown in the drawings, which are briefly described below.

FIG. 1 is a perspective view of the interior of a vehicle with an overhead console projector lamp, according to one embodiment.

FIG. 2 is a perspective view of an overhead console projector lamp mounted to the vehicle ceiling, according to one embodiment.

FIG. 3 is a perspective view of an overhead console projector lamp wherein the courtesy light is lit, according to one embodiment.

FIG. 4 is a perspective view of an overhead console projector lamp wherein the left set of the projector lamps are lit, according to one embodiment.

FIG. 5 is a perspective view of an overhead console projector lamp wherein the right set of the projector lamps are lit, according to one embodiment.

FIG. 6 is a perspective view of an overhead console projector lamp wherein both sets of projector lamps are lit, according to one embodiment.

FIG. 7 is a perspective view of an overhead console projector lamp wherein the courtesy light and both sets of projector lamps are lit, according to one embodiment.

FIG. 8 is an exploded view of a console projector lamp, according to one embodiment.

FIG. 9 is an exploded view of a console projector lamp, according to one embodiment.

FIG. 10 is a perspective view of a reflector illuminating two independent lamps, according to one embodiment.

FIG. 11 is a sectional view of a single reflector illuminating two independent lamps, according to one embodiment.

FIG. 12 is a perspective view of an overhead console projector lamp, according to one embodiment.

### DESCRIPTION

Embodiments of the present device will be described below with reference to the accompanying drawings. It should be understood that the following description is intended to describe exemplary embodiments, and not to limit the disclosed device.

According to one embodiment, a console projector lamp for a vehicle interior is provided. The console projector lamp comprises at least one projector lamp set. Each projector lamp set includes one or more projector lamps. Each projector lamp set also may include a light source, a converging lens and an elliptical, parabolic, or free form reflector, or a combination of these. According to a further embodiment, the reflector can be an elliptical reflector. The elliptical reflector can be used to reflect light from a light source to illuminate each lamp in the projector lamp set. The projector lamp set is encased in a housing that can be mounted to a surface in the interior of the vehicle.

Projector lamps can be used in a console projector lamp, as described herein, or can be used by themselves as stand-alone lamps to illuminate an object within the interior of a vehicle. Furthermore, the projector lamps can also be used as lamps in other overhead consoles, as lamps along the side of a headliner, as lamps integrated into assist handles, as lamps in vent modules, and as other interior lamps known in the art.

According to one embodiment, the lamps emit incandescent light in a defined pattern to illuminate a specific target area. Alternatively, the light source is a white LED, which can provide low power consumption and can be arranged to produce various attractive colors, such as with a colored filter. According to an example, the converging lens has a clear cover. In contrast, the console projector lamp includes a courtesy light having a lens with metalized coating. According to another example, a clear lens can cover all light elements, such as the projector lamps and courtesy light of an overhead projector console.

According to still another embodiment, the housing further comprises at least one button for activating the light source, which may or may not be backlit, and may have a light pipe encircling the button, wherein the light pipe may be activated when the light source is activated. Preferably, the housing is mounted on the ceiling of the vehicle. Further, the interior of the housing may be chrome.

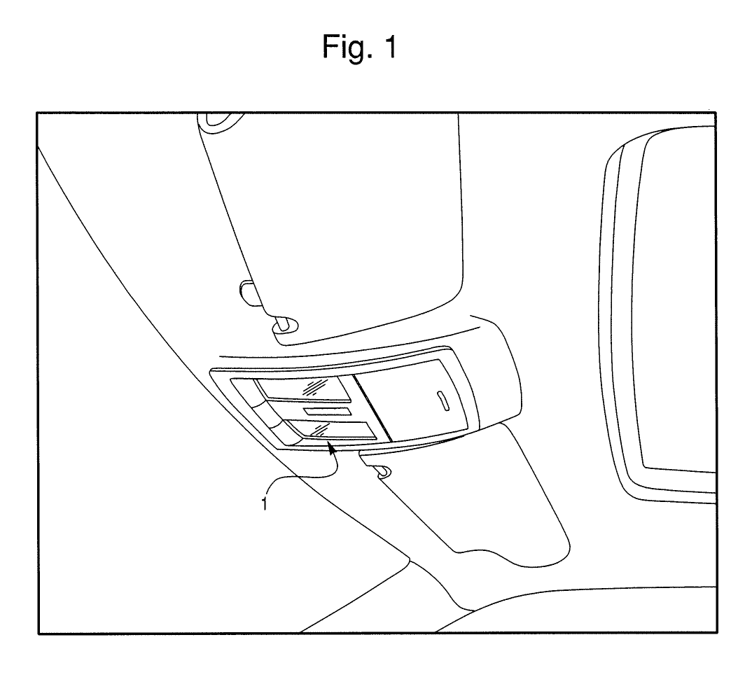

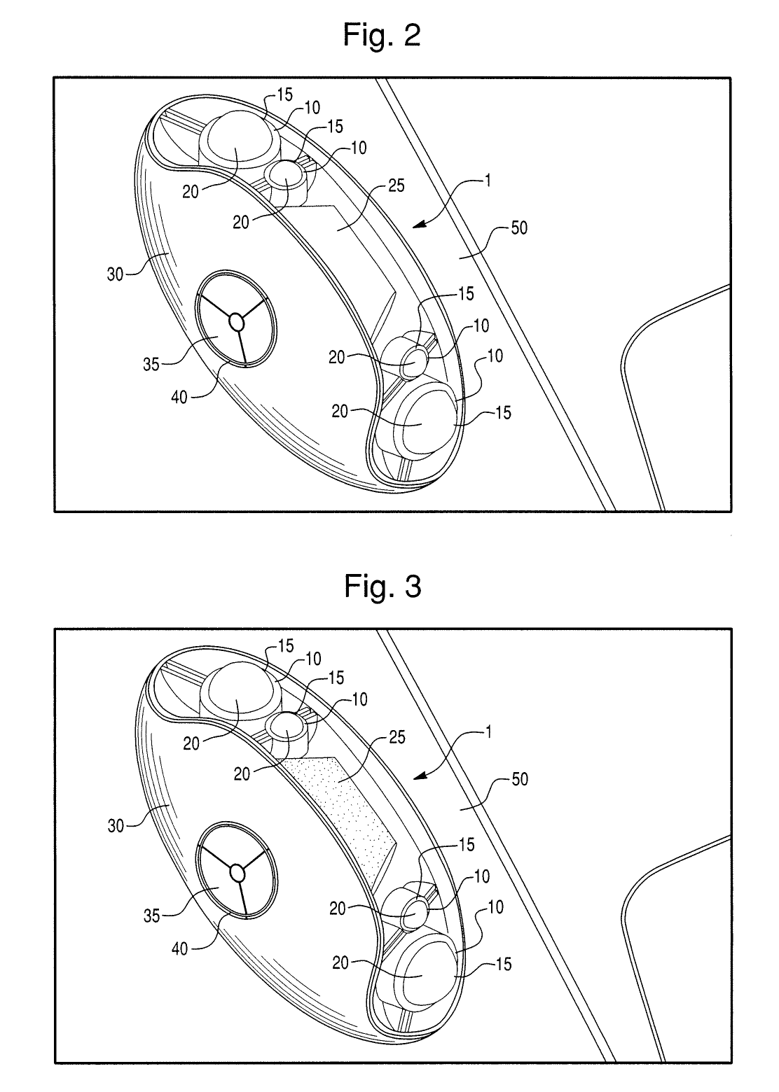

FIG. 1 illustrates an overhead console projector lamp 1 mounted in the interior of a vehicle, according to one embodiment. FIG. 2 is a perspective view of an overhead console projector lamp mounted to the vehicle ceiling, according to an embodiment.

The overhead console projector lamp 1 can include at least one projector lamp set 10. As shown in the example of FIG. 2, an overhead console projector lamp 1 can include two projector lamp sets 10. Each projector lamp set 10 can include one or more projector lamps 15. Each projector lamp set 10 can also include a light source (not shown in FIG. 2), a converging lens 20 and a reflector (not shown in FIG. 2). The reflector can be used to reflect light from a light source to illuminate each lamp 15 in a projector lamp set 10. According to another embodiment, two separate reflectors can be used for each lamp in the lamp set 10.

Further, according to this embodiment, the console projector lamp 1 includes a courtesy light 25 positioned adjacent to a projector lamp set 10. The courtesy light 25 has a light source (not shown in FIG. 2) that provides light for the courtesy light 25. Preferably, the lens of the courtesy light 25 has a metalized coating, a tinted coating, a frosted coating, or no coating.

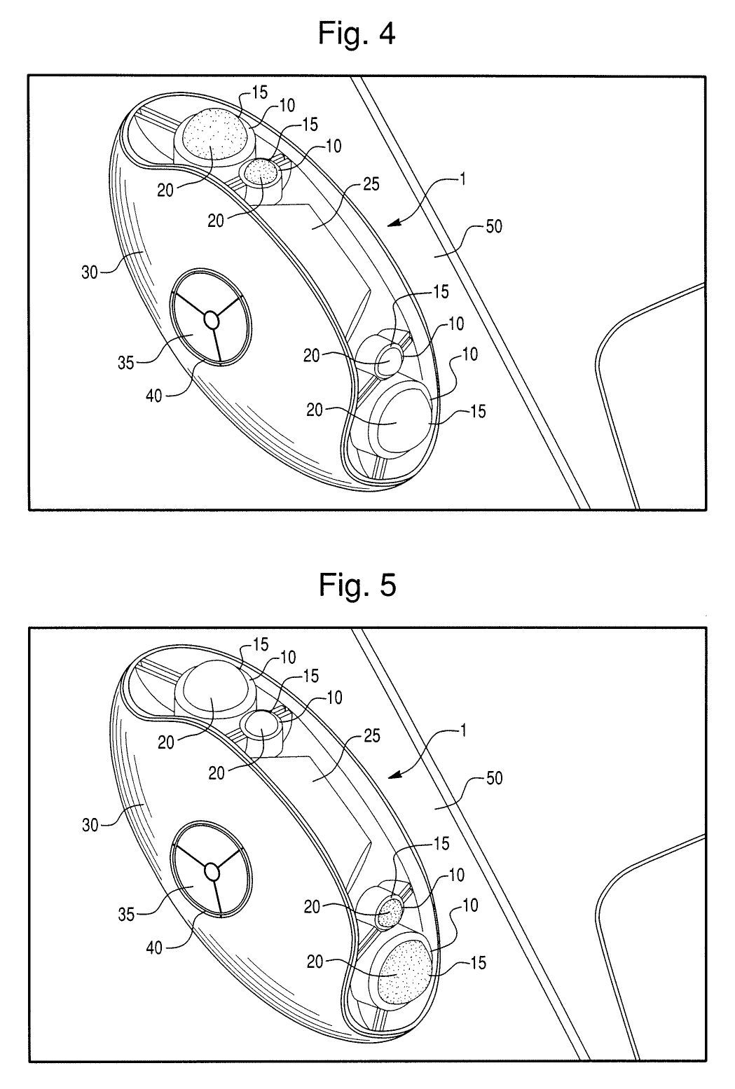

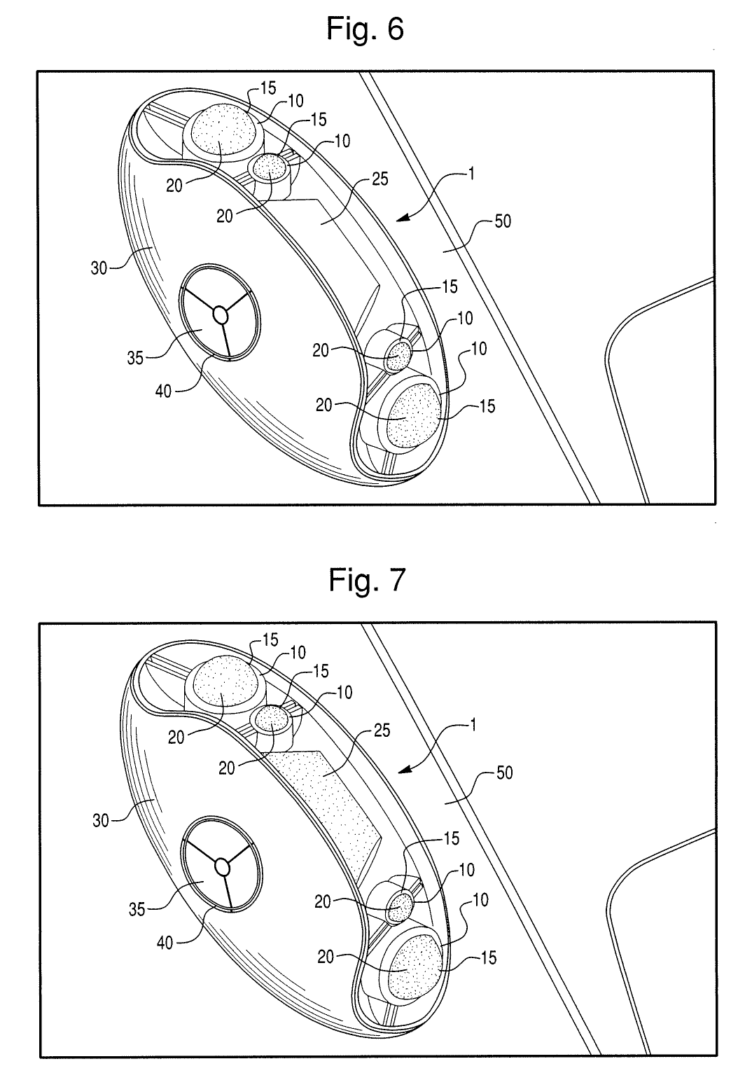

FIGS. 3-7 provide detailed views of an overhead console projector lamp 1 according to this embodiment. FIG. 3 is a perspective view of an overhead console projector lamp 1 wherein the courtesy light 25 is lit. FIG. 4 is a perspective view of an overhead console projector lamp 1 wherein the left set of the projector lamps 10 are lit. FIG. 5 is a perspective view of an overhead console projector lamp 1 wherein the right set of the projector lamps 10 are lit. FIG. 6 is a perspective view of an overhead console projector lamp 1 wherein both sets of projector lamps 10 are lit. FIG. 7 is a perspective view of an overhead console projector lamp 1 wherein the courtesy light 25 and both sets of projector lamps 10 are lit.

As shown in the examples of FIGS. 2-7 and 12, the overhead console projector lamp 1 preferably has two projector lamp sets 10, with each projector lamp set 10 having two projector lamps 15.

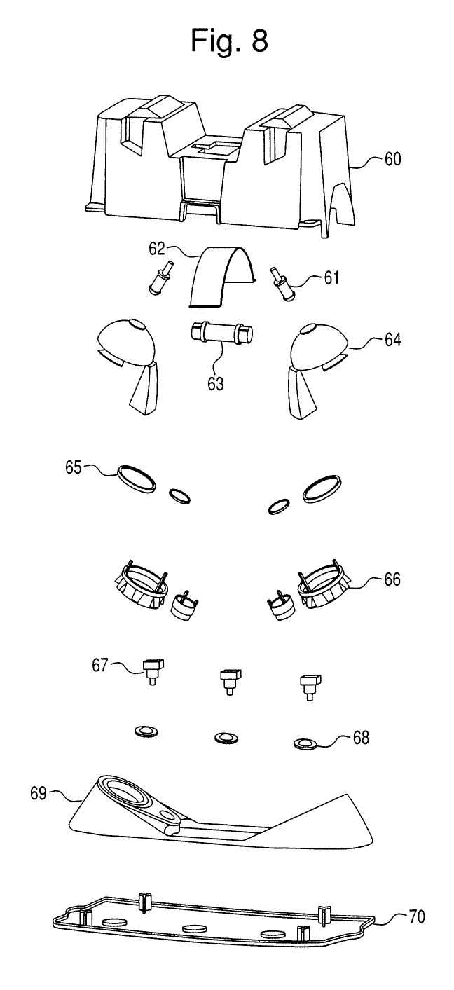

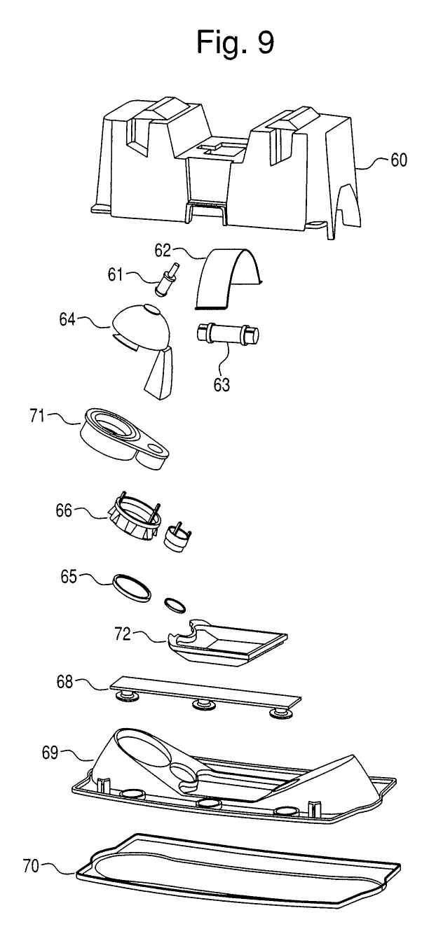

FIGS. 8 and 9 are exploded views of an overhead projector console projector lamp 1, according to an embodiment. The overhead console projector lamp 1 can include a bulb housing 60, a lamp bulb 61, a courtesy reflector 62, a map lamp reflector 64, a courtesy bulb 63 that can be a light source for a courtesy light 25, a lens housing 71, a lens bezel 66, switches 67, a map lens 65, a courtesy lens 72, a switch board 68, a bezel 69, and a film or lens 70.

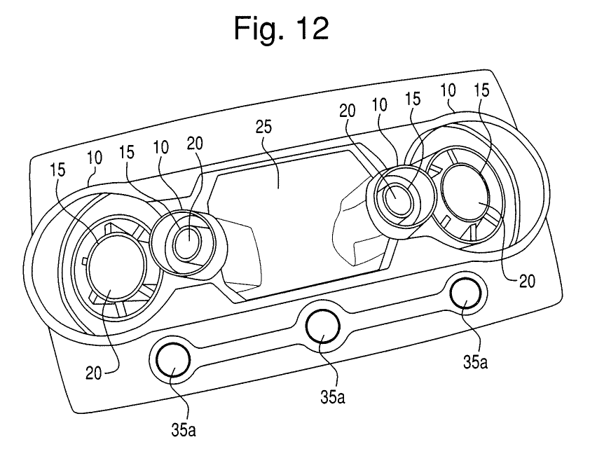

FIG. 12 is a perspective view of an overhead console projector lamp, according to an embodiment. The overhead console projector lamp can include at least one projector lamp set 10 with at least one projector lamp 15 and a converging lens 20. The overhead console projector lamp can also include a courtesy light 25. As shown in the example of FIG. 12, buttons 35a can be arranged so that there is a button 35a for each projector lamp set 10 and courtesy light 25. According to another example, the overhead console projector lamp can have buttons 35, as shown in the examples of FIGS. 2-7.

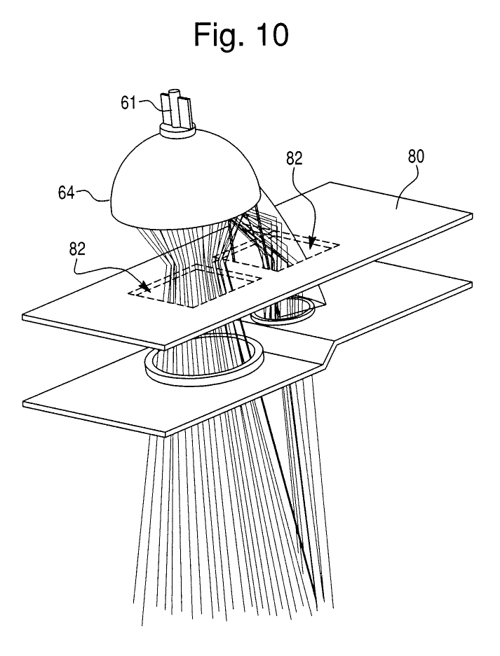

FIG. 10 is a perspective view of a light source, such as a lamp bulb 61, and a reflector 64 for illuminating two independent lamps, according to an embodiment. As shown in the example of FIG. 10, the overhead console projector lamp 1 can further include a light shield 80, which is shown as a transparent object in FIG. 10 so that the light pattern can be more easily viewed in FIG. 10. The light shield 80 can include at least one aperture 82 that is arranged to permit light reflected by the reflector 64 to pass through the light shield 80 to one of the projector lamps 15. The light shield 80 can further include at least two apertures 82, as shown in the example of FIG. 10, that are each configured to permit a portion of light reflected by the reflector 64 to pass through the light shield 80 and to one of the projector lamps 15. When the light shield 80 is used with a projector lamp set 10 that includes two projector lamps 15, the light shield 80 can include two apertures 82 that are each aligned with one of the projector lamps 15 so that light reflected from the reflector 64 passes through the apertures 82 and to each of the projector lamps 15.

The size and shape of the apertures 82 can be configured to control light reflected from the reflector 64 and/or shield uncontrolled light emitted directly from the light source. For example, the size and shape of the apertures 82 can be configured to create a narrow, focused beam of light that illuminates a particular object within an interior of a vehicle without permitting stray light from passing through the light shield 80. Stray light can needlessly illuminate other objects within the interior of a vehicle, such as the eyes of a driver of the vehicle.

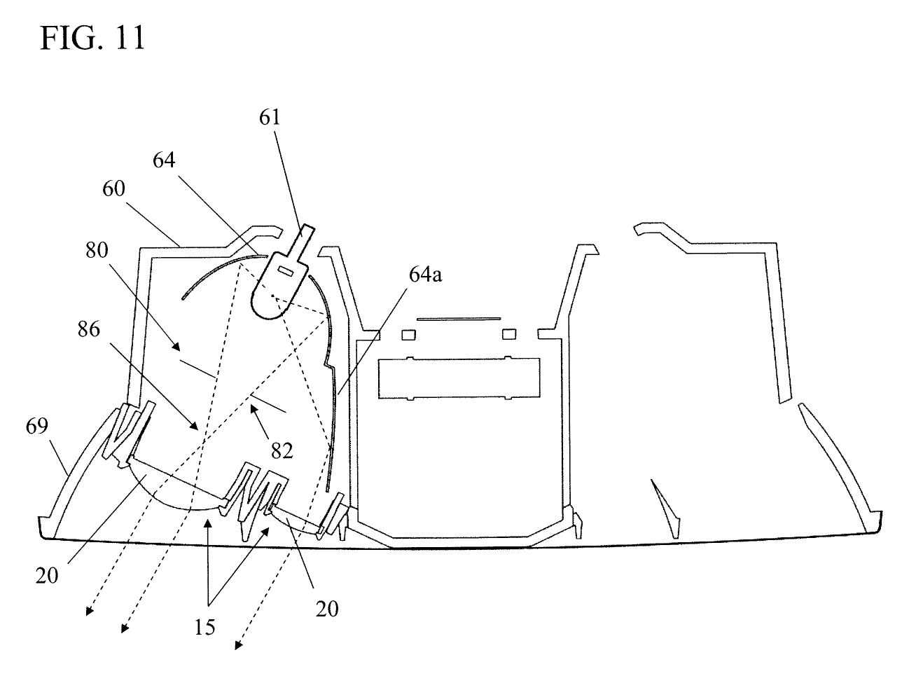

FIG. 11 is a sectional view of a single reflector illuminating two independent lamps, according to one embodiment. The dashed lines shown in FIG. 11 represent light emitted from lamp bulb 61. The reflector 64, which can be an elliptical reflector, can be configured to have two focal points, with one focal point arranged at the location of the light source, or lamp bulb 61, and, as shown in the example of FIG. 11, a second focal point 86 arranged at a point in front of the reflector. The reflector 64 is configured so that all light reflected by the reflector 64 passes through the second focal point 86. The second focal point 86 is arranged between the reflector 64 and a projector lamp 15. The location of focal points of the reflector 64 can be controlled, for example, by the size and/or shape of the reflector 64. A projector lamp 15 can include a converging lens 20 for focusing or controlling the pattern of light reflected from the reflector 64.

According to an embodiment, at least a portion of the light emitted from the lamp bulb 61 is reflected by the reflector 64, focused by the reflector at the second focal point 86, and then passed through a converging lens 20 of a projector lamp 15. The effect of such an arrangement is the creation of a narrowed light beam that can be concentrated or focused on certain areas, points or objects in a passenger compartment of a vehicle, such as a map being held by the driver, the dashboard of the vehicle, or other objects within the passenger compartment. The light emitted and focused by this arrangement can be emitted in a defined pattern to illuminate a specific target area within the interior of a vehicle. Thus, the overhead console projector lamp 1 is arranged to provide a very defined light pattern output with minimal stray light through the use of a reflector and a converging lens.

According to a further embodiment, the reflector 64 can include a secondary reflector 64a that is arranged to reflect light to a second projector lamp 15. As shown in the example of FIG. 11, a reflector 64 can be arranged for use with two projector lamps 15 by arranging the reflector 64 so that the reflector 64 directs light to one of the two projector lamps 15, while the secondary reflector 64a reflects and directs light to the other of the two projector lamps 15. As in the previous embodiment, each projector lamp 15 can include a converging lens 20, permitting the arrangement to produce a narrowed light beam that can be focused on an object in the passenger compartment of a vehicle.

According to a further embodiment, the overhead console projector lamp 1 can further include a light shield 80 that is arranged to permit at least a portion of the light reflected from the reflector 64 to pass through an aperture 82 in the light shield 80. In this manner, the light shield 80 can be configured to block stray light that has not been reflected by the reflector 64 and light following a path that is not aligned with an aperture 82 of the light shield 80. The light shield 80 can be arranged to permit light reflected from the reflector 64 to pass through the aperture 82 in the light shield 80, through the second focal point 86, and through a converging lens 20 of a projector lamp 15 to create a focused beam of light. Thus, this arrangement can provide an overhead console projector lamp 1 with greater control over a light pattern, permitting the overhead console projector lamp 1 to produce a very defined light pattern output with minimal stray light through the use of a reflector, a light shield 80, and a converging lens 20.

According to an even further embodiment, the light shield 80 can be configured to a have a second aperture 82 arranged above a projector lamp 15, such as in the example of FIG. 10, that is arranged to permit light reflected from secondary reflector 64a to pass through the aperture 82 in the light shield 80 and then through a converging lens 82 in the projector lamp 15 aligned with the aperture 82 of the light shield 80 to create a focused beam of light.

Accordingly, and as shown in FIGS. 10 and 11, a single reflector and a single light source can be used to illuminate two independent projector lamps 15. Alternatively, a secondary ambient or low intensity light source (not shown) may be used to provide an ambient lighting feature, such as through the smaller projector lamp 15. Consequently, the overhead console projector lamp 1 provides a very defined light pattern output with minimal stray light through the use of a reflector and converging lens 20. Such a defined light pattern can be used to illuminate a particular object in the interior of a vehicle without producing stray light that can, for example, shine into the eyes of a driver of a vehicle. Furthermore, such an arrangement can provide light while creating the appearance of a hidden light source due to the configuration of the reflector and the converging lens.

According to one embodiment, the projector lamps 15 use an incandescent light source. Alternatively, the light source may be a white LED. Due to the optic design of the reflector and the converging lens 20, the incandescent light is emitted in a defined pattern to illuminate a specific target area. Preferably, the converging lens 20 has a clear cover, but may be tinted.

The projector lamp set 15 and courtesy light 25 (if available) are encased in a housing 30 that can be mounted to an interior surface 50 of the vehicle, as shown in the examples of FIGS. 2-7. According to an embodiment, the housing 30 further comprises at least one button 35 or 35a, which may be comprised of multiple buttons for controlling the respective lamp sets 10 and courtesy light 25. Alternatively, multiple buttons may be used. Buttons 35 or 35a for activating a light source may or may not be backlit and may have a light pipe 40 encircling the button, wherein the light pipe 40 may be activated and lit when the light source corresponding to that button is activated or deactivated. Preferably, the housing 30 is mounted on the ceiling of the vehicle. Further, the interior of the housing 30 may be chrome or have a metalized appearance.

According to the above-described embodiments, the present device has several advantages. The overhead console projector lamp provides a unique lighting concept that will differentiate the appearance of the interior lighting. For example, the overhead console projector lamp is capable of illuminating two independent lamps with a single reflector. Accordingly, the overhead console projector lamp provides a very defined light pattern output with minimal stray light through the use of an elliptical reflector and converging lens in an efficient package of optics and electrical components. Thus, the overhead console projector lamp can be used as an effective map light or to precisely illuminate vehicle features that reside in the passenger cabin. Moreover, the overhead console projector lamp can be integrated with other electronic car systems such as a compass, HomeLink® or OnStar®.

The foregoing description of preferred embodiments have been presented for purposes of illustration and description. It is not intended to be exhaustive or to limit the disclosed device to the precise form disclosed, and modifications and variations are possible in light of the above teaching. The embodiment was chosen and described in order to explain the principles of the device and as a practical application to enable one skilled in the art to utilize the device in various embodiments and with various modification are suited to the particular use contemplated.

What is claimed is:

1. An overhead console projector lamp for the interior of a vehicle, comprising:
at least one projector lamp set comprising a light source, a reflector, and at least one projector lamp that includes a converging lens,
wherein the reflector is configured to include a first focal point and a second focal point,
wherein the light source is arranged at the first focal point of the reflector,
wherein the second focal point is located between the reflector and the converging lens.

2. The overhead console projector lamp of claim 1, further comprising a light shield that includes at least one aperture, wherein the aperture is configured to permit light reflected from the reflector to pass through the light shield and on to the converging lens.

3. The overhead console projector lamp of claim 2, wherein the light shield is located between the reflector and the converging lens.

4. The overhead console projector lamp of claim 1, wherein the projector lamp is a first projector lamp, and further comprising a second projector lamp.

5. The overhead console projector lamp of claim 4, wherein the reflector is configured to reflect light to both the first projector lamp and to the second projector lamp, wherein there is only one light source for the projector lamp set.

6. The overhead console projector lamp of claim 5, wherein the reflector further comprises a secondary reflector that is configured to reflect light to the second projector lamp.

7. The overhead console projector lamp of claim 4, further comprising a light shield that includes at least a first aperture, wherein the first aperture is configured to permit light reflected from the reflector to pass through the light shield and on to the converging lens of the first projector lamp.

8. The overhead console projector lamp of claim 7, wherein the light shield further comprises a second aperture, wherein the second aperture is configured to permit light reflected from the reflector to pass through the light shield and on to a converging lens of the second projector lamp.

9. The overhead console projector lamp of claim 1, further comprising a courtesy light.

10. A projector lamp set for the interior of a vehicle, comprising:
a light source,
a reflector, and
at least one projector lamp that includes a converging lens,
wherein the reflector is configured to include a first focal point and a second focal point,
wherein the light source is arranged within the reflector at the first focal point,
wherein the second focal point is located between the reflector and the converging lens.

11. The projector lamp set of claim 10, further comprising a light shield that includes at least one aperture, wherein the aperture is configured to permit light reflected from the reflector to pass through the light shield and on to the converging lens.

12. The projector lamp set of claim 11, wherein the projector lamp is a first projector lamp, and further comprising a second projector lamp.

13. The projector lamp set of claim 12, wherein the reflector is configured to reflect light to both the first projector lamp and to the second projector lamp, wherein there is only one light source for the projector lamp set.

14. The projector lamp set of claim 13, wherein the reflector further comprises a secondary reflector that is configured to reflect light to the second projector lamp.

15. The projector lamp set of claim 11, further comprising a light shield that includes at least a first aperture, wherein the first aperture is configured to permit light reflected from the reflector to pass through the light shield and on to the converging lens of the first projector lamp.

16. The overhead console projector lamp of claim 15, wherein the light shield further comprises a second aperture, wherein the second aperture is configured to permit light reflected from the reflector to pass through the light shield and on to a converging lens of the second projector lamp.
